(19) United States
(12) Patent Application Publication
(10) Pub. No.: US 2018/0049085 A1
(43) Pub. Date: Feb. 15, 2018

(54) Concurrent Connectivity Techniques

(71) Applicant: Apple Inc., Cupertino, CA (US)

(72) Inventors: Haijing Hu, Beijing (CN); Dawei Zhang, Saratoga, CA (US); Huarui Liang, Beijing (CN)

(21) Appl. No.: 15/027,523

(22) PCT Filed: Feb. 5, 2016
(86) PCT No.: PCT/CN2016/073600

§ 371 Date: Apr. 6, 2016

(51) Int. Cl. H04W 36/08; H04W 8/08; H04W 72/04

(52) U.S. Cl. CPC H04W 36/08; H04W 72/0446; H04W 8/08; H04W 88/02

(57) ABSTRACT

Techniques are disclosed relating to concurrent wireless connectivity. In some embodiments, a base station apparatus includes one or more processing elements and one or more memories having program instructions stored thereon that are executable by the one or more processing elements to perform the following operations. In some embodiments, the operations include communicating with a mobile device as a master base station during a time interval in which the mobile device is also assigned radio resources by a first secondary base station. In some embodiments, the operations include requesting that a second secondary base station allocate radio resources for the mobile device during the time interval, without releasing the first secondary base station, such that radio resources of both the first and second secondary base stations are allocated to the mobile device during the time interval.

### TECHNICAL FIELD

The present application relates to wireless devices, and more particularly to techniques for concurrent connectivity of a mobile device to multiple wireless base stations.

### DESCRIPTION OF THE RELATED ART

Wireless communication systems are rapidly growing in usage. Further, wireless communication technology has evolved from voice-only communications to also include the transmission of data, such as Internet and multimedia content. In some networks, dual-connectivity techniques allow a mobile device to communicate using scheduled radio resources of multiple base stations during the same time interval. One of the base stations may be a master base station (referred to in LTE as a MeNB) with a connection to a mobility management entity (MME) for the mobile device. The other base station may be a secondary base station (referred to in LTE as a SeNB) that provides additional radio resources.

When switching to a different SeNB, the MeNB releases a current source SeNB (S-SeNB) when allocation of a new target SeNB (T-SeNB) is successful. Traditionally, it is not possible to keep resources for the mobile device on both the S-SeNB and the T-SeNB, which reduces throughput during the handover procedure. This reduction in throughput may be substantial, especially in situations with small SeNB cells that are densely deployed such that handover occurs frequently.

Therefore, techniques for concurrent connectivity of multiple SeNBs (e.g., after successful allocating a T-SeNB) may be desired. Further, techniques for deciding when to release an S-SeNB may be desired.

### SUMMARY

Embodiments described herein relate to concurrent wireless connectivity. In some embodiments, a base station apparatus includes one or more processing elements and one or more memories having program instructions stored thereon that are executable by the one or more processing elements to perform the following operations. In some embodiments, the operations include communicating with a mobile device as a master base station during a time interval in which the mobile device is also assigned radio resources by a first secondary base station. In some embodiments, the operations include requesting that a second secondary base station allocate radio resources for the mobile device during the time interval, without releasing the first secondary base station, such that radio resources of both the first and second secondary base stations are allocated to the mobile device during the time interval.

In some embodiments, the request is an addition request that indicates that one or more current secondary base stations will not be released, wherein the apparatus is configured not to release the first secondary base station in response to receiving an acknowledgment to the addition request that indicates one or more current secondary base stations should not be released.

In some embodiments, the apparatus is configured to release the first secondary base station from connection with the mobile device in response to a signal strength measurement for the first secondary base station that is reported by the mobile device. In some embodiments, the apparatus is configured to release the first secondary base station from connection with the mobile device in response to an indication from the first secondary base station.

In some embodiments, the master base station is a master eNB (MeNB) that terminates at least one S1-MME connection for the mobile device and wherein the first and second secondary base stations are secondary eNBs (SeNBs) that do not maintain S1-MME connections for the mobile device.

In some embodiments, a method includes communicating with a mobile device as a master base station during a time interval in which the mobile device is also assigned radio resources by a first secondary base station. In some embodiments, the method further includes requesting that a second secondary base station allocate radio resources for the mobile device during the time interval, without releasing the first secondary base station, such that radio resources of both the first and second secondary base stations are allocated to the mobile device for communicating during the time interval.

In some embodiments, a mobile device apparatus includes one or more processing elements and one or more memories having program instructions stored thereon that are executable by the one or more processing elements to perform the following operations. In some embodiments, the operations include communicating via a master base station and a first secondary base station using radio resources allocated by both the master base station and the secondary base station during a time interval. In some embodiments, the operations include receiving a configuration message from the master base station indicating that radio resources are also available on a second secondary base station, wherein the master base station does not release the first secondary base station in response to addition of the second secondary base station. In some embodiments, the operations include communicating, during the time interval, using radio resources allocated by both the first and second secondary base stations.

In various embodiments, the disclosed techniques may increase wireless data throughput relative to conventional techniques.

### BRIEF DESCRIPTION OF THE DRAWINGS

A better understanding of the present disclosure can be obtained when the following detailed description of the embodiments is considered in conjunction with the following drawings.

FIG. 1 illustrates an example user equipment (UE) according to some embodiments.

FIG. 2 illustrates an example wireless communication system where a UE communicates with two base stations.

FIG. 3 is an example block diagram of a base station, according to some embodiments.

FIG. 4 is an example block diagram of a UE, according to some embodiments.

FIG. 5 illustrates an exemplary wireless communication system with concurrent connectivity, according to some embodiments.

FIG. 6 is a communications diagram illustrating dual connectivity, according to some embodiments.

FIG. 7 is a communications diagram illustrating concurrent connectivity, according to some embodiments.

FIG. 8 is a flow diagram illustrating an exemplary method, according to some embodiments.

While the embodiments described in this disclosure may be susceptible to various modifications and alternative forms, specific embodiments thereof are shown by way of example in the drawings and are herein described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component.

### DETAILED DESCRIPTION OF THE EMBODIMENTS

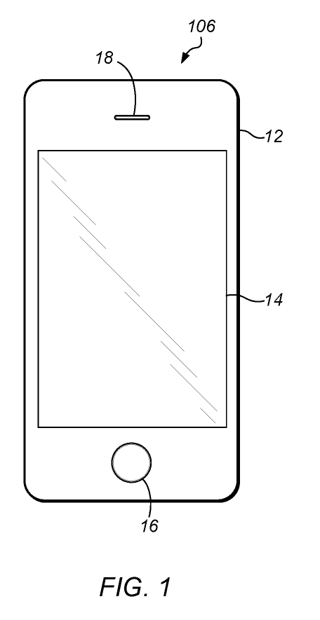

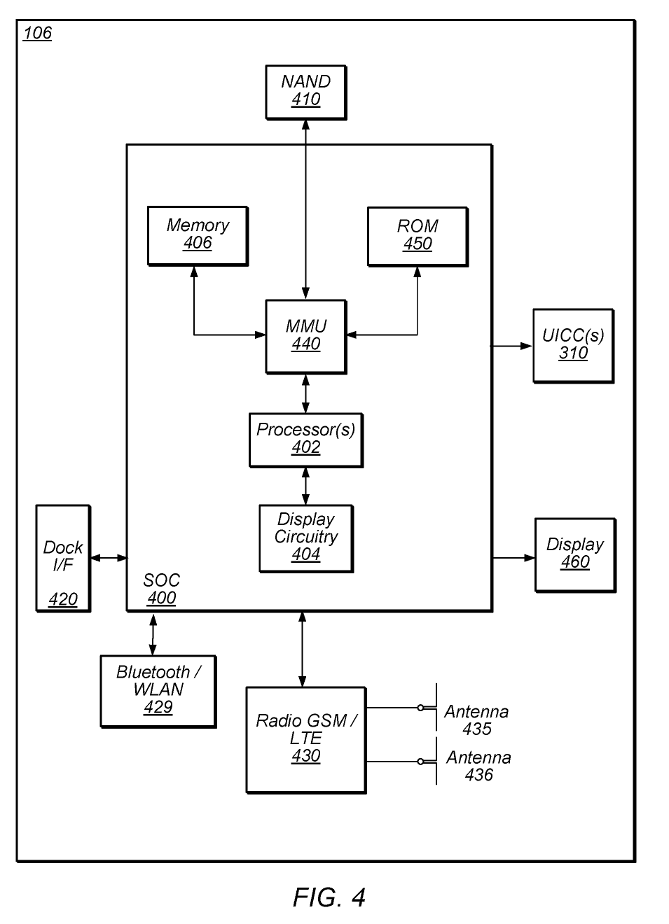

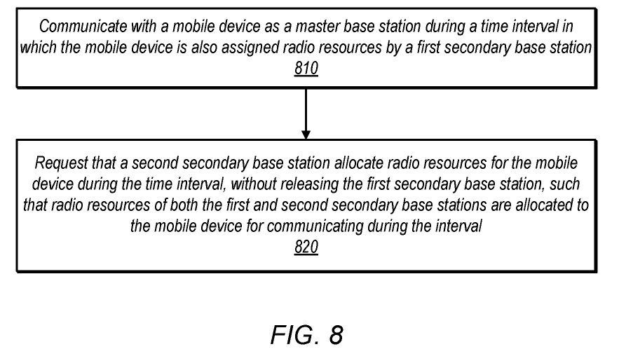

This disclosure initially lists relevant acronyms and a glossary. It then describes, with reference to FIGS. 1-4, exemplary embodiments of communications between a mobile device and one or more base stations. Exemplary concurrent connectivity systems and techniques are discussed with reference to FIGS. 4-7 while FIG. 8 illustrates an exemplary method.

### Acronyms

The following acronyms are used in the present disclosure.

3GPP: Third Generation Partnership Project

3GPP2: Third Generation Partnership Project 2

BER: Bit Error Rate

CDMA: Code Division Multiple Access

CPTR: Common Periodic Time Reference

DDR: Double Data Rate

eNB: evolved node B

EVM: Error Vector Magnitude

FFT: Fast Fourier Transform

FPGA: Field Programmable Gate Array

GSM: Global System for Mobile Communications

LTE: Long Term Evolution

MeNB: Master eNB

MIMO: Multiple Input Multiple Output

MRT: Maximum Radio Transmission

OFDM: Orthogonal Frequency-Division Multiplexing

PER: Packet Error Rate

PCIe: Peripheral Component Interconnect Express

PLMN: Public Land Mobile Network

PXIe: PCI eXtensions for Instrumentation Express

RAT: Radio Access Technology

RX: Receive

SDR: Software Defined Radio

SeNB: Seconday eNB

S-SeNB: Source SeNB

SRP: Software Radio Peripheral

T-SeNB: Target SeNB

TX: Transmit

UE: User Equipment

UMTS: Universal Mobile Telecommunications System

WCDMA: Wideband Code Division Multiple Access

ZF: Zero Forcing

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, PDAs, portable Internet devices, music players, data storage devices, other handheld devices, as well as wearable devices such as wrist-watches, headphones, pendants, earpieces, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

### FIG. 1—User Equipment

FIG. 1 illustrates an example user equipment (UE) 106 according to some embodiments. The term UE 106 may be any of various devices as defined above. UE device 106 may include a housing 12 which may be constructed from any of various materials. UE 106 may have a display 14, which may be a touch screen that incorporates capacitive touch electrodes. Display 14 may be based on any of various display technologies. The housing 12 of the UE 106 may contain or comprise openings for any of various elements, such as home button 16, speaker port 18, and other elements (not shown), such as microphone, data port, and possibly various other types of buttons, e.g., volume buttons, ringer button, etc.

The UE 106 may support one or more radio access technologies (RATs). For example, UE 106 may be configured to communicate using any of various RATs such as two or more of Global System for Mobile Communications (GSM), Universal Mobile Telecommunications System (UMTS), Code Division Multiple Access (CDMA) (e.g., CDMA2000 1XRTT or other CDMA radio access technologies), Long Term Evolution (LTE), LTE Advanced (LTE-A), and/or other RATs. For example, the UE 106 may support at least two radio access technologies such as LTE and GSM. Various different or other RATs may be supported as desired.

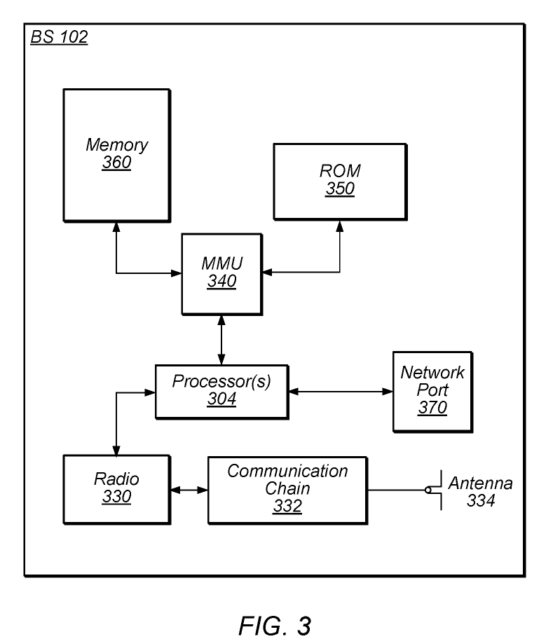

The UE 106 may comprise one or more antennas. The UE 106 may also comprise any of various radio configurations, such as various combinations of one or more transmitter chains (TX chains) and two or more receiver chains (RX chains). For example, the UE 106 may comprise two radios that may each support one or more RATs. The two radios may each comprise a single TX (transmit) chain and a single RX (receive) chain. Alternatively, the two radios may each comprise an RX chain and may share a single TX chain. UE 106 is described in further detail below with reference to FIG. 3.

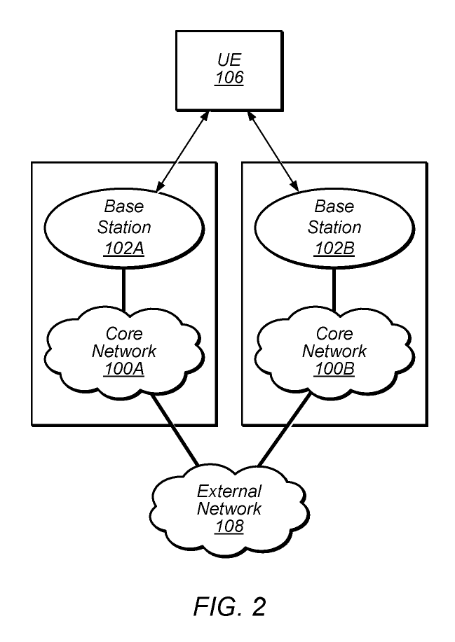

### FIG. 2—Communication System

FIG. 2 illustrates an exemplary (and simplified) wireless communication system. It is noted that the system of FIG. 2 is merely one example of a possible system, and embodiments may be implemented in any of various systems, as desired.

As shown, the exemplary wireless communication system includes base stations 102A and 102B which communicate over a transmission medium with one or more user equipment (UE) devices, represented as UE 106. The base stations 102 may be base transceiver stations (BTS) or cell sites, and may include hardware that enables wireless communication with the UE 106. Each base station 102 may also be equipped to communicate with a core network 100. For example, base station 102A may be coupled to core network 100A, while base station 102B may be coupled to core network 100B. Each core network 100 may also be coupled to one or more external networks (such as external network 108), which may include the Internet, a Public Switched Telephone Network (PSTN), and/or any other network. Thus, the base stations 102 may facilitate communication between the UE devices 106 and/or between the UE devices 106 and the networks 100A, 100B, and 108.

The base stations 102 and the UEs 106 may be configured to communicate over the transmission medium using any of various RATs (also referred to as wireless communication technologies or telecommunication standards), such as LTE, W-CDMA, TD-SCDMA, and GSM, among possible others such as UMTS, LTE-A, CDMA2000 (e.g., 1xRTT, 1xEV-DO, HRPD, eHRPD), etc.

Base stations 102A and 102B and other base stations operating according to the same or different RATs or cellular communication standards may thus be provided as a network of cells, which may provide continuous or nearly continuous overlapping service to UE 106 and similar devices over a wide geographic area via one or more radio access technologies (RATs).

### FIG. 3—Base Station

FIG. 3 illustrates an exemplary block diagram of a base station 102. It is noted that the base station of FIG. 3 is merely one example of a possible base station. As shown, the base station 102 may include processor(s) 304 which may execute program instructions for the base station 102. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 102 may include at least one network port 370. The network port 370 may be configured to couple to a telephone network and provide a plurality of devices, such as UE devices 106, access to the telephone network as described above.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices 106 serviced by the cellular service provider).

The base station 102 may include at least one antenna 334. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various RATs, including, but not limited to, LTE, GSM, WCDMA, CDMA2000, etc.

The processor(s) 304 of the base station 102 may be configured to implement part or all of the methods described herein, e.g., by executing program instructions stored on a memory medium (e.g., a non-transitory computer-readable memory medium). Alternatively, the processor 304 may be configured as a programmable hardware element, such as an FPGA (Field Programmable Gate Array), or as an ASIC (Application Specific Integrated Circuit), or a combination thereof.

FIG. 4—User Equipment (UE)

FIG. 4 illustrates an example simplified block diagram of a UE 106. As shown, the UE 106 may include a system on chip (SOC) 400, which may include portions for various purposes. The SOC 400 may be coupled to various other circuits of the UE 106. For example, the UE 106 may include various types of memory (e.g., including NAND flash 410), a connector interface 420 (e.g., for coupling to a computer system, dock, charging station, etc.), the display 460, cellular communication circuitry 430 such as for LTE, GSM, etc., and short range wireless communication circuitry 429 (e.g., Bluetooth and WLAN circuitry). The UE 106 may further comprise two or more smart cards 310 that each comprise SIM (Subscriber Identity Module) functionality, such as two or more UICC(s) (Universal Integrated Circuit Card(s)) 310. The cellular communication circuitry 430 may couple to one or more antennas, preferably two antennas 435 and 436 as shown. The short range wireless communication circuitry 429 may also couple to one or both of the antennas 435 and 436 (this connectivity is not shown for ease of illustration).

As shown, the SOC 400 may include processor(s) 402 which may execute program instructions for the UE 106 and display circuitry 404 which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, cellular communication circuitry 430, short range wireless communication circuitry 429, connector I/F 420, and/or display 460. The MMU 440 may be configured to perform memory protection and page table translation or set up. In some embodiments, the MMU 440 may be included as a portion of the processor(s) 402.

The processor 402 of the UE device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the UE device 106, in conjunction with one or more of the other components 400, 404, 406, 410, 420, 430, 435, 440, 450, 460 may be configured to implement part or all of the features described herein. In some embodiments, one or more processing elements of the UE device may be manufactured and/or sold separately from the UE device, but may be configured to perform various functionality described herein.

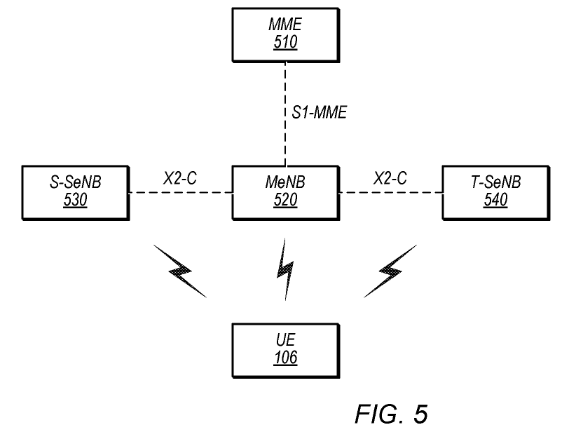

### FIGS. 5-7—Exemplary Concurrent Connectivity Techniques

FIG. 5 illustrates a system in which UE 106 is configured to be concurrently connected to MeNB 520, S-SeNB 530, and T-SeNB 540, according to some embodiments. In this situation, radio resources are scheduled for UE 106 on both S-SeNB 530 and T-SeNB 540 during the same time interval. This may increase throughput, e.g., when transitioning from S-SeNB 530 to T-SeNB 540, relative to dual-connectivity implementations in which MeNB 520 is configured to release S-SeNB 530 when handing over from S-SeNB 530, to T-SeNB 540, before resources are scheduled on T-SeNB 540.

In various exemplary embodiments discussed herein, the term MeNB is used to describe a master base station and SeNB to describe a secondary base station. These terms are not intended to limit the scope of the disclosure to LTE embodiments, however, but are merely used for illustrative purposes. The disclosed techniques may be used in any of various types of networks in addition to or in place of LTE networks.

In the illustrated embodiment, the MeNB 520 terminates an S1-MME interface to the MME 510 for UE 106. In the illustrated embodiment, the SeNBs 530 and 540 are configured to communicate with the MeNB via X2-C interfaces. In some embodiments, the base stations are configured to communicate with each other via an X2-U interface and are configured to communicate with a serving gateway (SGW) via an S1-U interface (X2-U and S1-U interfaces not shown).

In some embodiments, MeNB 520 is a master base station configured to service a larger coverage area than the SeNBs 530 and 540 (which may be picocell or femtocell base stations, for example). In other embodiments, the base stations may each be configured to service similarly-sized areas. In some embodiments, the base stations may operate in different modes (e.g., master at one point in time and secondary at another point in time) for a given UE, and/or may serve as a master base station for a first UE while also serving as a secondary base station for a second UE at the same time. In various embodiments, the base stations (e.g., MeNB 520, S-SeNB 530, and T-SeNB 540) may be synchronized.

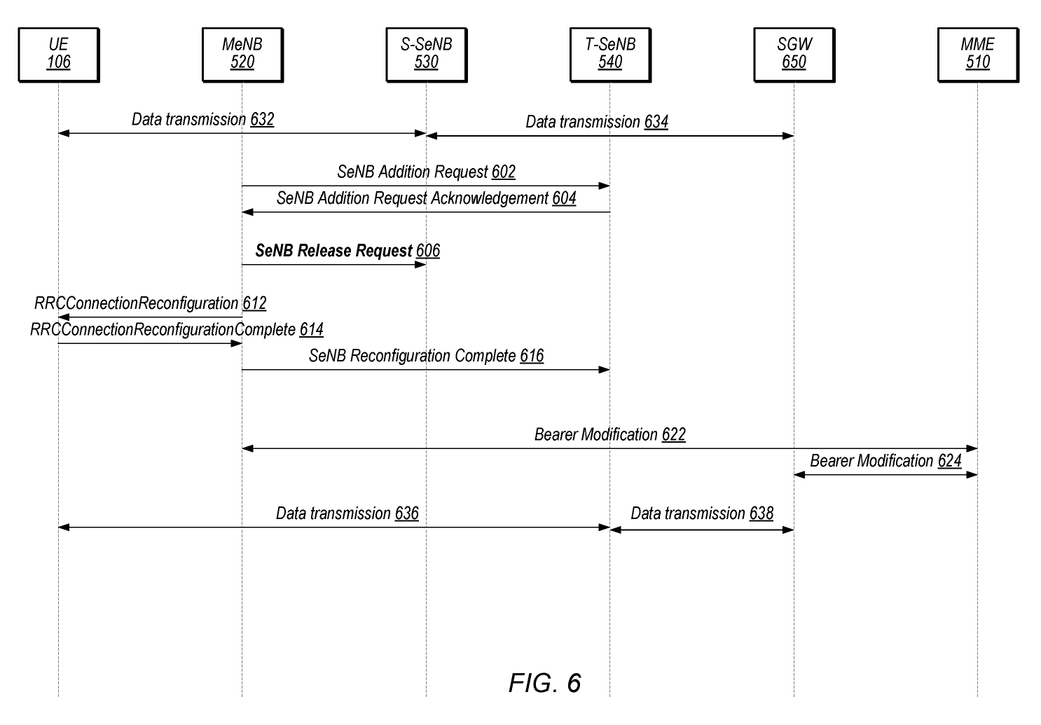

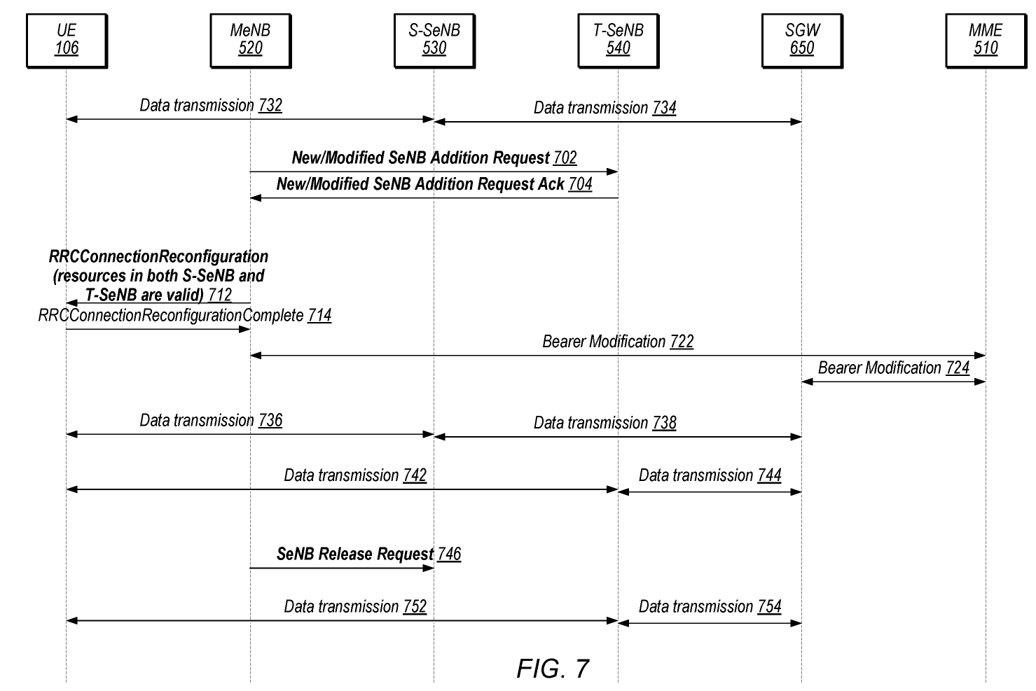

FIG. 6 is a communications diagram illustrating a handover technique with a release of the S-SeNB 530 while FIG. 7 is a communications diagram illustrating techniques for concurrent connectivity of the S-SeNB 530 and T-SeNB 540, according to some embodiments. In FIGS. 6 and 7, elements with the same reference numbers as used in FIG. 5 may be configured as discussed above. In FIGS. 6 and 7, messages are arranged from top to bottom according to passing time, e.g., such that data transmission 632 is performed before bearer modification 622, which is in turn performed before data transmission 636. These communications diagrams are shown for illustrative purposes but are not intended to limit the scope of the present disclosure. Rather, various messages may be replaced, modified, rearranged in time, etc., and additional messages may be used in addition to and/or in place of various disclosed messages.

In FIG. 6, in the illustrated embodiment, UE 106 initially communicates with a serving gateway (SGW) 650 via S-SeNB 530, as shown by data transmissions 632 and 634. In some embodiments, UE 106 also communicates with the SGW 650 via the MeNB 520 during the same interval (data transmissions not explicitly shown), using dual-connectivity techniques.

In the illustrated embodiment, MeNB 520 then sends an addition request 602 to the T-SeNB 540 and receives an acknowledgement 604. After receiving the acknowledgement, MeNB 520 sends a release request 606 to the S-SeNB 530. This may reduce throughput, as the UE 106 may be unable to communicate via an SeNB until connection with T-SeNB 540 is fully configured. T-SeNB 540 may be configured to schedule radio resources for UE 106 subsequent to RRC reconfiguration via messages 612 and 614 and bearer modification via message 622 and 624. At this point, the UE 106 may transfer data to and/or from SGW 650 via the T-SeNB 540 (as shown by data transmissions 636 and 638).

In FIG. 7, in contrast, the S-SeNB 530 is not released until after the connection to T-SeNB 540 is fully configured, and radio resources for the UE 106 may be scheduled by both the S-SeNB 530 and T-SeNB 540 during the same time interval.

In the illustrated embodiment, after data transmissions 732 and 734 via the S-SeNB 530, MeNB 520 sends a new or modified SeNB addition request 702. The request may be a new type of message that indicates (e.g., by its name or type) that the current SeNB (S-SeNB 530) should not be released at least until connectivity to the T-SeNB is established. In other embodiments, the request may be a modified version of a conventional SeNB Addition Request message, e.g., that indicates in a field of the modified message whether or not to release the current SeNB upon receiving a response to the message.

In the illustrated embodiment, T-SeNB 540 responds with a new/modified SeNB Addition Request Acknowledgement 704. Similar to the message 702, this may be a new type of message or may include a new field that indicates to MeNB 520 not to release the current SeNB upon receiving message 704. Messages 702 and 704, in some embodiments, include other information needed for the Addition Request and Addition Request Acknowledgement process. In the illustrated embodiment, MeNB 520 is configured not to release S-SeNB 530, based on receiving the new-modified SeNB Addition Request Acknowledgement 704 (in the illustrated embodiment, S-SeNB 530 is not released until later, based on message 746). Various techniques for deciding when to release the S-SeNB (and/or T-SeNB) from concurrent connectivity are discussed in further detail below.

In the illustrated embodiment, MeNB 520 then sends an RRCConnectionReconfiguration message 712 to UE 106. At this point, resources in both the S-SeNB and T-SeNB are valid for UE 106, which may be indicated by message 712. Subsequently, UE 106 responds with an RRCConnectionReconfigurationComplete message 714 and a bearer modification is performed using messages 722 and 724. In some embodiments, the modified bearer may be a split bearer that corresponds to radio resources in the MeNB and one or more SeNBs.

At this point, UE 106, in the illustrated embodiment, is scheduled radio resources on both S-SeNB and T-SeNB during the same time interval, as shown by data transmissions 736, 738, 742, and 744. In some embodiments, these transmission may overlap in time, e.g., using different frequency resources. In other embodiments, these transmissions may overlap in frequency but be scheduled for different time slots during the time interval in which both SeNBs are allocated for UE 106. The disclosed techniques may prevent a decrease in throughput when transitioning from S-SeNB 530 and T-SeNB 540 and may also increase throughput while both (or more) SeNBs are concurrently connected.

In the illustrated embodiment, MeNB 520 subsequently sends a SeNB release request 746 to release S-SeNB 530 and UE 106 proceeds with data transmissions 752 and 754 via T-SeNB 540 via T-SeNB 540 but no longer communicates via S-SeNB 530.

MeNB 520, in some embodiments, is configured to determine to release the S-SeNB 530 based on one or more of various criteria. In some embodiments, the master base station is configured to release an SeNB in response to UE 106 reporting poor radio connectivity on the SeNB cell. This may be determined, for example, based on reference signal received power (RSRP) measurements reported by UE 106. In some embodiments, the master base station is configured to release an SeNB based on information from the SeNB itself. As a first example, this information may indicate that no downlink transmissions have been performed for a threshold time interval for UE 106 by the SeNB. As a second example, this information may indicate that a number of NACK messages for UE 106 exceeds a certain threshold. As a third example, this information may indicate that a threshold number of radio link control (RLC) retransmissions have been performed for UE 106. As a fourth example, this information may indicate detection of physical layer problems. In other embodiments, the determination to release the SeNB may be based on one or more other criteria in place of and/or in addition to the exemplary criteria listed.

### FIG. 8—Exemplary Method

FIG. 8 shows a method for configuring concurrent connectivity for a mobile device, according to some embodiments. The method shown in FIG. 8 may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired.

At 810, in the illustrated embodiment, a base station communicates with a mobile device as a master base station during a time interval in which the mobile device is also assigned radio resources by a first secondary base station. Note that a given base station may be a master base station for a mobile device at a first point in time (e.g., when it terminates an S1-MME interface for the mobile device) and a secondary base station at a later point in time. The first secondary base station may be a source secondary base station such as S-SeNB 530, for example.

At 820, in the illustrated embodiment, the base station requests that a second secondary base station (e.g., T-SeNB 540) allocate radio resources for the mobile device during the time interval. In the illustrated embodiment, the master base station makes this request and receives an acknowledgement from the second secondary base station without releasing the first secondary base station. In the illustrated embodiment, this allows radio resources of both the first and second secondary base stations to be allocated to the mobile device for communicating during the time interval.

In some embodiments, the request in 820 is a new or modified addition request. In some embodiments, the master base station does not release the first secondary base station in response to receiving a new or modified acknowledgement to the addition request. In various embodiments, this may avoid reductions in throughput during handover between secondary base stations.

In some embodiments, the master base station is configured to release the first secondary base station, after the time interval, based on information received from the mobile device or from the first secondary base station.

Embodiments described in this disclosure may be realized in any of various forms. For example, some embodiments may be realized as a computer-implemented method, a computer-readable memory medium, or a computer system. Other embodiments may be realized using one or more custom-designed hardware devices such as ASICs. Other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE or a base station) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus, comprising:
one or more processing elements; and
one or more memories having program instructions stored thereon that are executable by the one or more processing elements to:
communicate with a mobile device as a master base station during a time interval in which the mobile device is also assigned radio resources by a first secondary base station; and
request that a second secondary base station allocate radio resources for the mobile device during the time interval, without releasing the first secondary base station, such that radio resources of both the first and second secondary base stations are allocated to the mobile device during the time interval.

2. The apparatus of claim 1, wherein the request is an addition request that indicates that one or more current secondary base stations will not be released, wherein the apparatus is configured not to release the first secondary base station in response to receiving an acknowledgment to the addition request that indicates one or more current secondary base stations should not be released.

3. The apparatus of claim 1, wherein the apparatus is configured to release the first secondary base station from connection with the mobile device in response to a signal strength measurement for the first secondary base station that is reported by the mobile device.

4. The apparatus of claim 1, wherein the apparatus is configured to release the first secondary base station from connection with the mobile device in response to an indication from the first secondary base station.

5. The apparatus of claim 4, wherein the indication from the first secondary base station is based on at least one of:
an absence of downlink data transmission from the first secondary base station to the mobile device over a threshold interval;
a number of negative acknowledgement messages for the mobile device exceeding a threshold;
a number of radio link control (RLC) retransmissions for the mobile device exceeding a threshold; or
detection of a physical layer problem for the mobile device.

6. The apparatus of claim 1, wherein the program instructions are further executable to:
transmit a connection configuration message to the mobile device that indicates that resources in both the first and second secondary base stations are valid.

7. The apparatus of claim 1, wherein the master base station is a master eNB (MeNB) that terminates at least one S1-MME connection for the mobile device and wherein the first and second secondary base stations are secondary eNBs (SeNBs) that do not maintain S1-MME connections for the mobile device.

8. A method, comprising:
communicating with a mobile device as a master base station during a time interval in which the mobile device is also assigned radio resources by a first secondary base station; and
requesting that a second secondary base station allocate radio resources for the mobile device during the time interval, without releasing the first secondary base station, such that radio resources of both the first and second secondary base stations are allocated to the mobile device for communicating during the time interval.

9. The method of claim 8, wherein the request is an addition request that indicates that one or more current secondary base stations will not be released, wherein the master base station is configured not to release the first secondary base station in response to receiving an acknowledgment to the addition request that indicates one or more current secondary base stations should not be released.

10. The method of claim 8, further comprising:
releasing the first secondary base station from connection with the mobile device in response to a signal strength measurement for the first secondary base station that is reported by the mobile device.

11. The method of claim 8, further comprising:
releasing the first secondary base station from connection with the mobile device in response to an indication from the first secondary base station.

12. The method of claim 11, wherein the indication from the first secondary base station is based on at least one of:
an absence of downlink data transmission from the first secondary base station to the mobile device over a threshold interval;
a number of negative acknowledgement messages for the mobile device exceeding a threshold;
a number of radio link control (RLC) retransmissions for the mobile device exceeding a threshold; or
detection of a physical layer problem for the mobile device.

13. The method of claim 8, further comprising:
transmitting a connection configuration message to the mobile device that indicates that resources in both the first and second secondary base stations are valid.

14. The method of claim 8, further comprising the master base station communicating with a mobility management entity (MME) via an S1-MME interface.

15. An apparatus, comprising:
one or more processing elements; and
one or more memories having program instructions stored thereon that are executable by the one or more processing elements to:
communicate via a master base station and a first secondary base station using radio resources allocated by both the master base station and the firstsecondary base station during a time interval;
receive a configuration message from the master base station indicating that radio resources are also available on a second secondary base station, wherein the master base station does not release the first secondary base station in response to addition of the second secondary base station; and
communicate, during the time interval, using radio resources allocated by both the first and second secondary base stations.

16. The apparatus of claim 15, wherein the configuration message is a radio resource control (RRC) reconfiguration message.

17. The apparatus of claim 15, wherein the radio resources allocated by the first and second secondary base stations overlap in time or frequency.

18. The apparatus of claim 15, wherein the program instructions are further executable to indicate to the master base station to release the first secondary base station based on a signal strength measured by the apparatus.

19. The apparatus of claim 15, wherein the master base station is a master eNB (MeNB) that terminates at least one S1-MME connection for the apparatus and wherein the first and second secondary base stations are secondary eNBs (SeNBs) that do not maintain S1-MME connections for the apparatus.

20. The apparatus of claim 15, wherein the apparatus is a mobile device that includes at least one antenna and at least one wireless radio configured to perform the communications.
